(19) United States
(12) Patent Application Publication
(10) Pub. No.: US 2015/0269293 A1
(43) Pub. Date: Sep. 24, 2015

(54) DIAGNOSTIC MODEL GENERATING APPARATUS AND METHOD, AND ABNORMALITY DIAGNOSTIC APPARATUS

(71) Applicant: KABUSHIKI KAISHA TOSHIBA, Minato-ku (JP)

(72) Inventors: Hisaaki HATANO, Yokohama (JP); Hideyuki AISU, Kawasaki (JP); Kenichi FUJIWARA, Kawasaki (JP)

(73) Assignee: KABUSHIKI KAISHA TOSHIBA, Minato-ku (JP)

(21) Appl. No.: 14/658,555

(22) Filed: Mar. 16, 2015

(30) Foreign Application Priority Data
Mar. 19, 2014 (JP) 2014-057027

(51) Int. Cl. G06F 17/50; G06F 17/18; G01M 99/00

(52) U.S. Cl. CPC G06F 17/5009; G01M 99/00; G06F 17/18

(57) ABSTRACT

In one embodiment, a diagnosis model generating apparatus includes a physical parameter calculator, a first residual calculator, a physical model determiner, a second residual calculator, a searcher, and a generator.

The physical parameter calculator calculates a parameter value of a parameter having an undetermined value of a first physical model. The first physical model represents a relationship between the variables. The first residual calculator calculates a first residual of the first physical model. The physical model determiner determines whether to adopt the first physical model. The second residual calculator calculates a second residual of the first physical model that has not been adopted by the physical model determiner. The searcher searches for a measured value correlated with the second residual from among measured values not assigned to the variables. The generator generates a second physical model. The second physical model represents a relationship between the variables.

### CROSS REFERENCE TO RELATED APPLICATION(S)

This application is based upon and claims the benefit of priority from the prior Japanese Patent Application No. 2014-057027, filed on Mar. 19, 2014, the entire contents of which are incorporated herein by reference.

### FIELD

Embodiments described herein relate generally to a diagnostic model generating apparatus and method, and an abnormality diagnostic apparatus.

### BACKGROUND

As a method of diagnosing whether there are abnormalities in air conditioning equipment, etc., there is known a diagnostic method using a diagnostic model that follows the laws of physics (hereinafter, referred to as a “physical model”). The physical model is a formula including, in general, variables for which predetermined measured values or control values (hereinafter, collectively referred to as “measured values or the like”) related to equipment are substituted and a parameter which is a predetermined constant value. Based on a value obtained by substituting the measured values or the like of diagnostic target equipment for the variables, whether there are abnormalities in the equipment is diagnosed. In this abnormality diagnostic method, even if there are a small number of measured values or the like to be substituted for the variables, relatively high diagnostic performance can be expected. However, in the abnormality diagnostic method, when measured values or the like to be substituted for the variables of the physical model cannot be obtained, a physical model needs to be regenerated, which may cause an increase in engineering cost.

### BRIEF DESCRIPTION OF THE DRAWINGS

FIG. 1 is a block diagram showing a functional configuration of a diagnostic model generating apparatus according to a first embodiment;

FIG. 2 is a diagram showing an example of measured values or the like stored in a measured value DB;

FIG. 3 is a block diagram showing a configuration of the diagnostic model generating apparatus according to the first embodiment;

FIG. 4 is a schematic configuration diagram showing a configuration of air conditioning equipment;

FIG. 5 is a flowchart showing a diagnosis model generation process performed by the diagnostic model generating apparatus according to the first embodiment;

FIG. 6 is a block diagram showing a functional configuration of a diagnostic model generating apparatus according to a second embodiment;

FIG. 7 is a flowchart showing a diagnosis model generation process performed by the diagnostic model generating apparatus according to the second embodiment;

FIG. 8 is a flowchart showing an assignment determination process performed by an assignment determiner according to the second embodiment;

FIG. 9 is a block diagram showing a functional configuration of a diagnostic model generating apparatus according to a third embodiment;

FIG. 10 is a flowchart showing a diagnostic model generation process performed by the diagnostic model generating apparatus according to the third embodiment;

FIG. 11 is a schematic configuration diagram showing a configuration of air conditioning equipment;

FIG. 12 is a block diagram showing a functional configuration of an abnormality diagnostic apparatus according to a fourth embodiment; and

FIG. 13 is a flowchart showing an abnormality diagnostic process performed by the abnormality diagnostic apparatus according to the fourth embodiment.

### DETAILED DESCRIPTION

Embodiments will now be explained with reference to the accompanying drawings. The present invention is not limited to the embodiments.

In one embodiment, a diagnosis model generating apparatus includes a physical parameter calculator, a first residual calculator, a physical model determiner, a second residual calculator, a searcher, and a generator. The physical parameter calculator calculates a parameter value of a parameter having an undetermined value of a first physical model, based on the first physical model and measured values. The first physical model represents a relationship between the variables based on a plurality of variables assigned the measured values and the parameter. The first residual calculator calculates a first residual of the first physical model, based on the first physical model, the parameter value, and the measured values. The physical model determiner determines whether to adopt the first physical model, based on the first residual. The second residual calculator calculates a second residual of the first physical model that has not been adopted by the physical model determiner, based on the first physical model, the measured values, and the parameter value. The searcher searches for a measured value correlated with the second residual from among measured values not assigned to the variables. The generator generates a second physical model based on a variable assigned the measured value searched for by the searcher, the variables of the first physical model, and a newly set parameter having an undetermined value. The second physical model represents a relationship between the variables.

Embodiments of a diagnostic model generating apparatus (hereinafter, referred to as the “generating apparatus”) and an abnormality diagnostic apparatus (hereinafter, referred to as the “diagnostic apparatus”) will be described below with reference to the drawings. The diagnostic apparatus described below is an apparatus for diagnosing whether there are abnormalities in various types of equipment such as air conditioning equipment provided in a building and water and sewer equipment. The diagnostic apparatus diagnoses whether there are abnormalities in the equipment, based on a value obtained by substituting measured values or the like into a predetermined physical model. The generating apparatus is an apparatus for generating a physical model used by the diagnostic apparatus. By using the generating apparatus and the diagnostic apparatus, remote monitoring of various types of equipment, etc., can be performed.

### First Embodiment

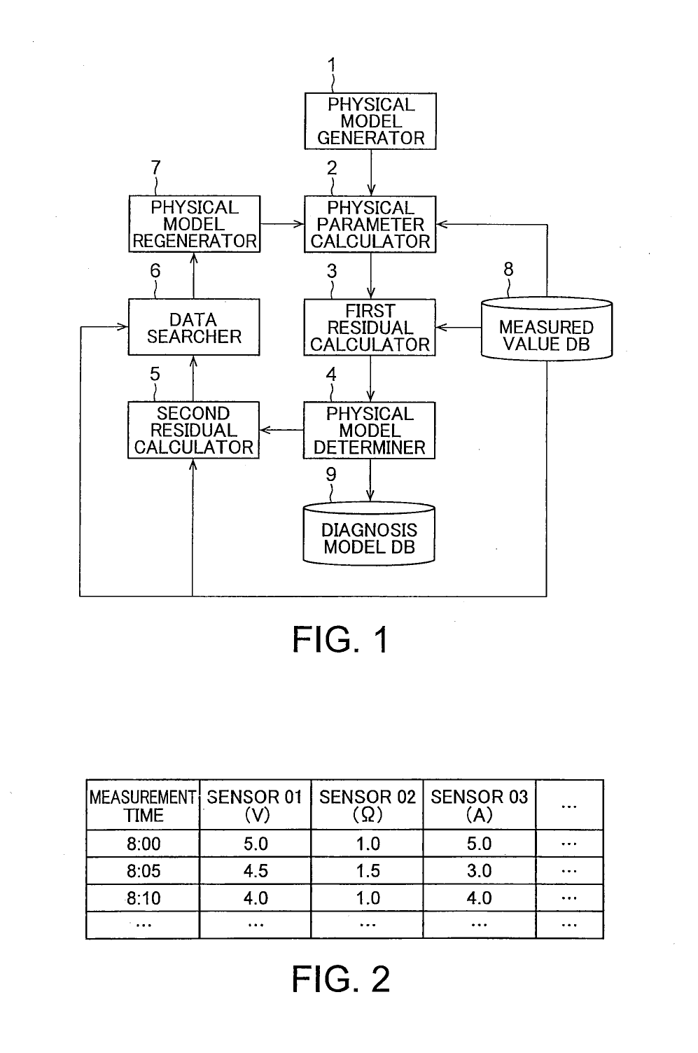

First, a generating apparatus according to a first embodiment will be described with reference to FIGS. 1 to 5. FIG. 1 is a block diagram showing a functional configuration of a generating apparatus according to the present embodiment. The generating apparatus of FIG. 1 includes a physical model generator 1, a physical parameter calculator 2, a first residual calculator 3 (first residual calculator), a physical model determiner 4, a second residual calculator 5 (second residual calculator), a data searcher 6 (measured value searcher), a physical model regenerator 7 (second physical model generator), a measured value DB 8, and a diagnosis model DB 9.

The physical model generator 1 generates an assigned physical model (first physical model) based on a pre-stored unassigned physical model. The unassigned physical model is a model representing a relationship between variables according to the laws of physics, based on a plurality of variables which are not assigned measured values or the like to be substituted and a parameter having an undetermined value. The unassigned physical model is, for example, a formula such as V(V)=R(Ω)×I(A). The above-described formula follows the laws of physics, but it is not determined which measured values or the like are to be assigned to the variables V, R, and I.

The physical model generator 1 generates an assigned physical model by assigning measured values or the like to be substituted, to the variables of the unassigned physical model. Therefore, the assigned physical model has a plurality of variables which are assigned measured values or the like to be substituted and a parameter having an undetermined value, according to the laws of physics. The assigned physical model is, for example, a formula where measured values or the like to be substituted are assigned to the variables V, R, and I of a formula such as the above-described V(V)=R(Ω)×I(A).

The physical model generator 1 may generate an assigned physical model by assigning measured values or the like to the variables of one unassigned physical model. Alternatively, the physical model generator 1 may generate an assigned physical model by generating a new unassigned physical model by combining a plurality of unassigned physical models so as to follow the laws of physics, and assigning measured values or the like to the variables of the unassigned physical model.

Furthermore, the physical model generator 1 can also generate an assigned physical model without assigning measured values or the like to some of the variables of an unassigned physical model. This is because measured values or the like to be assigned to the variables of an unassigned physical model are not always present. For example, when equipment is not provided with an ammeter, a measured value or the like to be assigned to the variable I(A) of the unassigned physical model “V(V)=R(Ω)×I(A)” cannot be obtained. In such a case, the physical model generator 1 generates an assigned physical model where measured values or the like are assigned to the variables V and R and a measured value or the like is not assigned to the variable I.

The physical parameter calculator 2 calculates the value of a parameter (parameter value) included in the assigned physical model, by substituting the assigned measured values or the like for the variables of the assigned physical model generated by the physical model generator 1. The measured values or the like to be substituted are evaluation measured values or the like which are measured when the sensors are found to be operating normally. The measured values or the like to be substituted into the assigned physical model are obtained from the measured value DB 8.

In addition, when the assigned physical model includes an unassigned variable, the physical parameter calculator 2 calculates a parameter value by substituting a predetermined constant value for the unassigned variable. The unassigned variable refers to a variable that is not assigned a measured value or the like to be substituted. By the physical parameter calculator 2 determining the parameter value, a physical model that can be used for actual abnormality diagnosis is generated.

The first residual calculator 3 (first residual calculator) calculates a first residual e1 by generating a first residual calculation formula based on a physical model generated by substituting the parameter value for the parameter of the assigned physical model, and substituting measured values or the like into the first residual calculation formula. When the physical model is represented by (left side)=(right side), the first residual calculation formula is “residual e1=(right side)−(left side)” or “residual e1=(left side)−(right side)”. Namely, the first residual calculator 3 calculates, as the residual e1, the difference between the right and left sides of the physical model. The first residual calculator 3 calculates the residual e1 by substituting evaluation measured values or the like into the first residual calculation formula such as that described above. The measured values or the like to be substituted into the first residual calculation formula are obtained from the measured value DB 8.

The physical model determiner 4 determines, based on the residual e1, whether to adopt the physical model from which the residual e1 is calculated, as a diagnosis physical model used for actual abnormality diagnosis. The physical model determiner 4 determines whether to adopt the physical model by, for example, comparing the average value, distribution, maximum value, minimum value, mode, etc., of a plurality of calculated residuals e1 with a threshold value. Alternatively, when each of the residual e1 and the threshold value is a set of a plurality of values, the physical model determiner 4 may determine whether to adopt the physical model, using the Kallback-Leibler Divergence, etc.

The threshold value may be preset or may be calculated for each generated physical model. For example, the physical model determiner 4 calculates a threshold value based on the design values of sensors. The design values as used herein refer to measured values which are predetermined as a criterion for abnormalities in sensors or equipment.

The second residual calculator 5 (second residual calculator) obtains a physical model that has not been adopted by the physical model determiner 4, determines whether the obtained physical model includes an unassigned variable, generates a second residual calculation formula according to the determination result, and calculates a second residual e2 by substituting measured values or the like into the second residual calculation formula.

When the physical model does not include an unassigned variable, the second residual calculation formula is “residual e2=(right side)−(left side)” or “residual e2=(left side)−(right side)”. Namely, the first residual calculation formula and the second residual calculation formula match each other and the residual e2 is the difference between the right and left sides of the physical model.

On the other hand, when the physical model includes an unassigned variable, the second residual calculator 5 calculates a residual e2 where the unassigned variable matches a dimension. For example, when the unassigned variable is I, the second residual calculator 5 transforms the physical model into the model “unassigned variable I=(right side)” and calculates, as the residual e2, the difference between the unassigned variable I and the right side. Namely, the second residual calculation formula for determining the residual e2 is “residual e2=(right side)−unassigned variable I” or “residual e2=unassigned variable I−(right side)”. A predetermined constant value is substituted for the unassigned variable I by the physical parameter calculator 2.

The second residual calculator 5 calculates the residual e2 by substituting a parameter value and an evaluation measured value or the like into the second residual calculation formula generated in the above-described manner. The measured value or the like to be substituted into the second residual calculation formula is obtained from the measured value DB 8.

The data searcher 6 searches for a measured value correlated with the residual e2 from among measured values not assigned to the variables among the evaluation measured values. The data searcher 6 calculates correlation coefficients between the residual e2 and the measured values by any method and selects a measured value whose correlation coefficient is greater than or equal to a predetermined value, as the measured value correlated with the residual e2.

The physical model regenerator 7 regenerates a new assigned physical model (second physical model) having a variable for which the measured value searched for (selected) by the data searcher 6 is substituted; and a newly set parameter having an undetermined value. Specifically, a new physical model is generated by substituting the searched measured value for the residual e2 of the above-described residual calculation formula. In addition, in the new physical model, a parameter having an undetermined value is newly set by initializing the parameter value of the original physical model or newly adding a parameter.

The measured value DB 8 stores measured values or the like. FIG. 2 is a diagram showing an example of measured values or the like stored in the measured value DB 8. As shown in FIG. 2, the measured value DB 8 stores measured values or the like for each measurement time. The measured value DB 8 may store only evaluation measured values or may store measured values or the like for an arbitrary period. In this case, some of the measured values or the like for the arbitrary period stored in the measured value DB 8 are used as evaluation measured values or the like.

The diagnosis model DB 9 stores the physical model adopted by the physical model determiner 4. The physical model stored in the diagnosis model DB 9 is used for actual abnormality diagnosis as a diagnosis physical model.

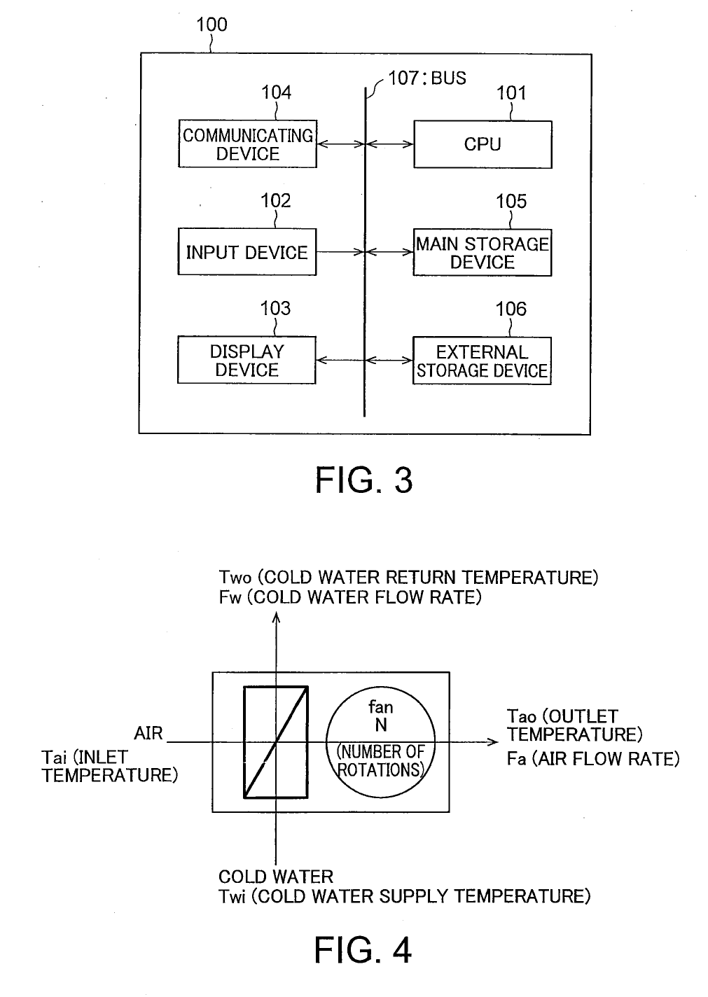

The generating apparatus described above can be implemented by using a computer apparatus 100 as basic hardware. As shown in FIG. 3, the computer apparatus 100 includes a CPU 101, an input device 102, a display device 103, a communicating device 104, a main storage device 105, and an external storage device 106, and they are communicably connected to each other by a bus 107.

The input device 102 includes input devices such as a keyboard and a mouse, and outputs to the CPU 101 operation signals generated by operations of the input devices. The display device 103 includes a display such as an LCD (Liquid Crystal Display) or a CRT (Cathode Ray Tube). The communicating device 104 has a wireless or wired communication means and performs communication by a predetermined communication scheme.

The external storage device 106 includes, for example, a storage medium such as a hard disk, a memory apparatus, a CD-R, a CD-RW, a DVD-RAM, or a DVD-R. The external storage device 106 stores a control program for allowing the CPU 101 to perform the processes of the generating apparatus. The functional configuration of the physical model generator 1, the physical parameter calculator 2, the first residual calculator 3, the physical model determiner 4, the second residual calculator 5, the data searcher 6, and the physical model regenerator 7 are implemented by the CPU 101 executing the control program. In addition, the external storage device 106 stores data in each storage means included in the generating apparatus. The measured value DB 8 and the diagnosis model DB 9 are configured by the external storage device 106.

The main storage device 105 expands the control program stored in the external storage device 106 under the control of the CPU 101 and stores data required when executing the program, data generated by the execution of the program, etc. The main storage device 105 includes, for example, any memory such as nonvolatile memory.

The control program may be pre-installed on the computer apparatus 100 or may be stored in a storage medium such as a CD-ROM and then installed on the computer apparatus 100 as appropriate. Note that it is also possible to employ a configuration not including the input device 102, the display device 103, and the communicating device 104.

Next, the operation of the generating apparatus according to the present embodiment will be described. In the following, the case of generating, by the generating apparatus, a physical model for abnormality diagnosis of air conditioning equipment will be described. FIG. 4 is a schematic configuration diagram showing a configuration of air conditioning equipment.

The air conditioning equipment of FIG. 4 is cooling equipment that cools air by heat exchange with cold water and supplies cool air into a room. In the air conditioning equipment, the temperature of intake air (inlet temperature) Tai, the temperature of exhaust air (outlet temperature) Tao, the flow rate of air (air flow rate) Fa, the temperature of cold water flowing in for heat exchange (cold water supply temperature) Twi, the temperature of cold water flowing out after heat exchange (cold water return temperature) Two, and the flow rate of cold water (cold water flow rate) Fw are measured by sensors. In addition, the number of rotations N of a blowing fan is obtained as a control value. These measured values and the like are stored in the measured value DB 8 and some of them are used as evaluation measured values or the like.

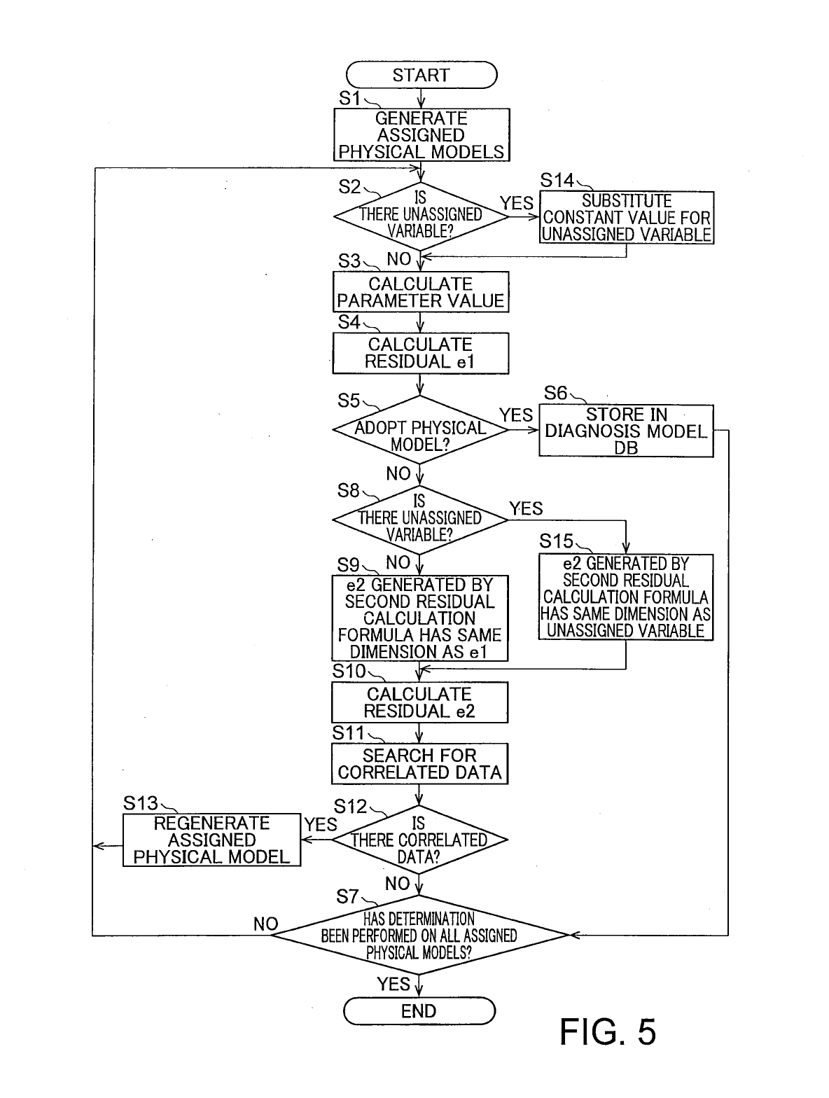

FIG. 5 is a flowchart showing a diagnosis model generation process of the generating apparatus. As shown in FIG. 5, when a diagnosis model generation process starts, the physical model generator 1 generates assigned physical models (step S1). Since the amounts of heat exchanged between air and cold water are equal in the air conditioning equipment of FIG. 4, the following assigned physical model is established according to the laws of physics:

(Two−Twi)×Fw=A×(Tai−Tao)×Fa (1)

In the above-described formula (1), Two, Twi, Fw, Tai, Tao, and Fa are variables which are assigned measured values, and A is a parameter having an undetermined value which is determined from the specific heats or densities of cold water and air. The physical model generator 1 generates a plurality of such assigned physical models.

There are two types of the assigned physical models generated by the physical model generator 1, i.e., one including an unassigned variable and one not including an unassigned variable. The processes performed after step S2 vary between when the assigned physical model includes an unassigned variable and when the assigned physical model does not include an unassigned variable.

First, the processes performed when the assigned physical model does not include an unassigned variable will be described.

When assigned physical models are generated by the physical model generator 1, the physical parameter calculator 2 obtains the plurality of assigned physical models generated by the physical model generator 1, selects one of the obtained assigned physical models, and determines whether the selected assigned physical model includes an unassigned variable (step S2). Here, it is assumed that the assigned physical model (1) has been selected.

If the assigned physical model (1) does not include an unassigned variable (NO at step S2), the physical parameter calculator 2 calculates a parameter value of the parameter A by substituting measured values or the like for the variables of the following formula which is a transformed version of the assigned physical model (1) (step S3):

A=(Two−Twi)×Fw/{(Tai−Tao)×Fa} (2)

The physical parameter calculator 2 may calculate a parameter value by substituting measured values or the like for a plurality of times such as those shown in FIG. 2 into formula (2). When a measured value for a time t (=t1, t2, . . . , tN) is represented as X(t), the parameter value is calculated by the following formula using the least squares method:

A=Σ[(Two(t)−Twi(t))×(Tai(t)−Tao(t))×Fw(t)×Fa(t)]/Σ[{(Tai(t)−Tao(t))×Fa(t)}²] (3)

The first residual calculator 3 substitutes the parameter value calculated by the above-described formula (2) or (3) into the assigned physical model (1) and thereby generates a physical model, and transforms the physical model and thereby generates a first residual calculation formula for calculating a residual e1. Since the residual e1 is the difference between the left and right sides of the physical model, the following formula is generated as the first residual calculation formula:

e1(t)=(Two(t)−Twi(t))×Fw(t)−[A]×(Tai(t)−Two(t))×Fa(t) (4)

In the above-described first residual calculation formula (4), [A] is the parameter value calculated by formula (2) or (3). In addition, the right side of the first residual calculation formula (4) is (left side)−(right side) of the physical model, but may be (right side)−(left side). The first residual calculator 3 calculates a residual e1 by substituting evaluation measured values or the like obtained from the measured value DB 8 into the generated first residual calculation formula (4) (step S4).

The physical model determiner 4 determines whether to adopt the physical model, based on the residual e1 calculated by the first residual calculator 3 (step S5). The determination method is as described above.

If the physical model determiner 4 determines to adopt the physical model (YES at step S5), the physical model is stored as a diagnosis physical model in the diagnosis model DB 9 (step S6). Thereafter, the physical model determiner 4 determines whether processes have been performed on all of the assigned physical models generated by the physical model generator 1 (step S7). If processes are done for all of the physical models (YES at step S7), the diagnosis model generation process ends. If there is an unprocessed assigned physical model (NO at step S7), processing returns to step S2 and the physical parameter calculator 2 selects a next assigned physical model.

On the other hand, if the physical model determiner 4 determines not to adopt the physical model (NO at step S5), the second residual calculator 5 obtains the unadopted physical model and determines whether the physical model includes an unassigned variable (step S8). If an unassigned variable is not included (NO at step S8), the second residual calculator 5 transforms the physical model and thereby generates a second residual calculation formula for calculating a second residual e2 (step S9). In this case, the second residual calculation formula is, as shown below, the difference between the left and right sides of the physical model.

e2(t)=(Two(t)−Twi(t))×Fw(t)−[A]×(Tai(t)−Tao(t))×Fa(t) (5)

The second residual calculator 5 calculates a residual e2 by substituting evaluation measured values or the like obtained from the measured value DB 8 into the generated second residual calculation formula (5) (step S10).

Then, the data searcher 6 obtains the residual e2(t) calculated by the second residual calculator 5 and searches for a measured value or the like correlated with the residual e2(t) from among the evaluation measured values or the like (step S11). The data searcher 6 searches for a measured value or the like by, for example, evaluating the cross-correlation between the residual e2(t) and the measured values. If a measured value or the like correlated with the residual e2(t) has not been found (NO at step S12), the process for the physical model ends and processing proceeds to step S7.

On the other hand, if a measured value or the like correlated with the residual e2(t) has been found (YES at step S12), the physical model regenerator 7 regenerates an assigned physical model based on the measured value or the like (step S13). For example, when the number of rotations N of the fan (control value) has been found as the measured value or the like having a high correlation with the residual e2(t), the physical model regenerator 7 substitutes a variable N(t) which is assigned the number of rotations N for the residual e2(t) of the second residual calculation formula (5) to initialize the parameter value A and thereby regenerates a new assigned physical model (second physical model).

B×N(t)=(Two(t)−Twi(t))×Fw(t)−A×(Tai(t)−Tao(t))×Fa(t) (6)

The above-described assigned physical model (6) includes N, Two, Twi, Fw, Tai, Tao, and Fa as variables and includes A and B as undetermined parameters. After the assigned physical model (6) is generated, processing returns to step S2 and the processes after step S2 are repeated for the assigned physical model (6).

Next, the case in which the assigned physical model includes an unassigned variable will be described. Here, it is assumed that the air flow rate Fa has not been measured.

When assigned physical models are generated by the physical model generator 1, the physical parameter calculator 2 obtains the plurality of assigned physical models generated by the physical model generator 1, selects one of the obtained assigned physical models, and determines whether the selected assigned physical model includes an unassigned variable (step S2). Here, it is assumed that the assigned physical model (1) has been selected.

If the assigned physical model (1) includes an unassigned variable Fa (YES at step S2), the physical parameter calculator 2 substitutes a predetermined constant value for the unassigned variable Fa (step S14) and substitutes measured values or the like for the variables of the following formula which is a transformed version of the assigned physical model (1), and thereby calculates a parameter value of the parameter A (step S3):

A=(Two−Twi)×Fw/{(Tai−Tao)×[Fa]} (7)

In the above-described formula (7), [Fa] is the predetermined constant value. As the constant value [Fa], for example, a numerical value set in the specifications of the air conditioning equipment is used.

The physical parameter calculator 2 may calculate a parameter value by substituting measured values or the like for a plurality of times such as those shown in FIG. 2 into formula (7). The parameter value is calculated by the following formula using the least squares method:

A=E[(Two(t)−Twi(t))×(Tai(t)−Tao(t))×Fw(t)×[Fa]]/Σ[{(Tai(t)−Tao(t))×[Fa]}²] (8)

The first residual calculator 3 substitutes the parameter value calculated by the above-described formula (7) or (8) into the assigned physical model (1) and thereby generates a physical model, and transforms the physical model and thereby generates a first residual calculation formula for calculating a residual e1. Since the residual e1 is the difference between the left and right sides of the physical model, the following formula is generated as the first residual calculation formula:

e1(t)=(Two(t)−Twi(t))×Fw(t)−[A]×(Tai(t)−Tao(t))×[Fa] (9)

In the above-described first residual calculation formula (9), [A] is the parameter value calculated by formula (7) or (8). In addition, the right side of the first residual calculation formula (4) is (left side)−(right side) of the physical model, but may be (right side)−(left side). The first residual calculator 3 calculates a residual e1 by substituting evaluation measured values or the like obtained from the measured value DB 8 into the generated first residual calculation formula (9) (step S4).

The physical model determiner 4 determines whether to adopt the physical model, based on the residual e1 calculated by the first residual calculator 3 (step S5). The determination method is as described above.

If the physical model determiner 4 determines to adopt the physical model (YES at step S5), the physical model is stored in the diagnosis model DB 9 (step S6). Thereafter, the physical model determiner 4 determines whether processes have been performed on all of the assigned physical models generated by the physical model generator 1 (step S7). If processes are done for all of the assigned physical models (YES at step S7), the diagnosis model generation process ends. If there is an unprocessed assigned physical model (NO at step S7), processing returns to step S2 and the physical parameter calculator 2 selects a next assigned physical model.

On the other hand, if the physical model determiner 4 determines not to adopt the physical model (NO at step S5), the second residual calculator 5 obtains the physical model and determines whether the physical model includes an unassigned variable (step S8). If the physical model includes an unassigned variable (YES at step S8), the second residual calculator 5 transforms the physical model and thereby generates a second residual calculation formula for calculating a second residual e2. First, the second residual calculator 5 transforms the physical model such that the unassigned variable Fa is on the left side (or the right side) and thereby generates the following formula:

[Fa]=(Two−Twi)×Fw/{[A]×(Tai−Tao)} (10)

The second residual calculator 5 generates a second residual calculation formula for determining the difference between the right and left sides of the above-described formula (10) (step S15).

e2(t)=(Two(t)−Twi(t))×Fw(t)/{[A]×(Tai(t)−Tao(t))}−[Fa] (11)

As shown in the above-described formula (11), the residual e2 is calculated as the difference between the right and left sides of formula (10). The second residual calculator 5 calculates a residual e2 by substituting evaluation measured values or the like obtained from the measured value DB 8 into the generated second residual calculation formula (11) (step S10).

Then, the data searcher 6 obtains the residual e2(t) calculated by the second residual calculator 5 and searches for a measured value or the like correlated with the residual e2(t) from among the evaluation measured values or the like (step S11). The data searcher 6 searches for a measured value or the like by, for example, evaluating the cross-correlation between the residual e2(t) and the measured values or the like. If a measured value or the like correlated with the residual e2(t) has not been found (NO at step S12), the process for the physical model ends and processing proceeds to step S7.

On the other hand, if a measured value or the like correlated with the residual e2(t) has been found (YES at step S12), the physical model regenerator 7 regenerates an assigned physical model based on the measured value or the like (step S13). For example, when the number of rotations N of the fan (control value) has been found as the measured value or the like having a high correlation with the residual e2(t), the physical model regenerator 7 substitutes a variable N(t) which is assigned the number of rotations N for the residual e2(t) of the second residual calculation formula (11) to initialize the parameter value A and thereby regenerates the following assigned physical model (second physical model):

B×N(t)=(Two(t)−Twi(t))×Fw(t)/{A×(Tai(t)−Tao(t))}−C (12)

The above-described assigned physical model (12) includes N, Two, Twi, Fw, Tai, and Tao as variables and includes A, B, and C as undetermined parameters. In addition, the parameter C is substituted for the variable Fa for which the predetermined constant value is substituted. After the assigned physical model (12) is generated, processing returns to step S2 and the processes after step S2 are repeated for the assigned physical model (12).

As described above, according to the generating apparatus according to the present embodiment, a new physical model can be easily generated using a measured value or the like correlated with a residual of a physical model. Accordingly, engineering cost for regenerating a physical model can be reduced. In addition, even when a measured value or the like to be assigned to a physical model cannot be obtained, the physical model is extended using a residual, enabling to generate a physical model.

Note that the generating apparatus can also employ a configuration not including the measured value DB 8 and the diagnosis model DB 9. In this case, the generating apparatus obtains measured values or the like from an external apparatus and stores a physical model adopted as a diagnosis model in a storage unit of the external apparatus.

### Second Embodiment

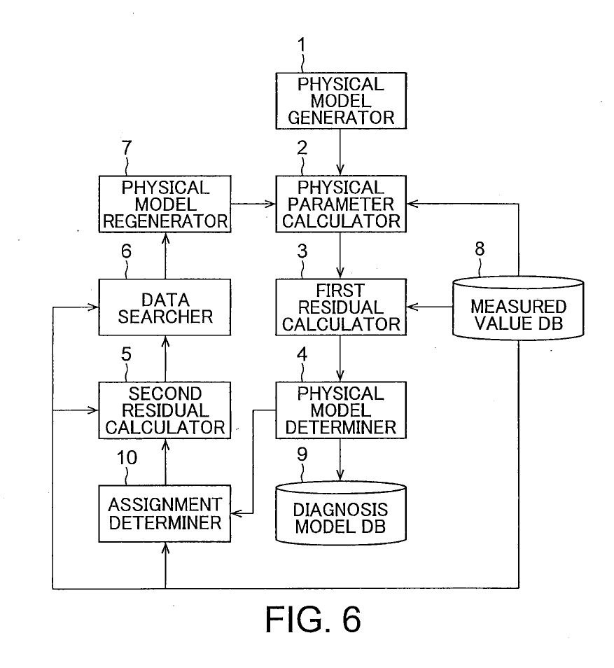

Next, a generating apparatus according to a second embodiment will be described with reference to FIGS. 6 to 8. FIG. 6 is a block diagram showing a functional configuration of a generating apparatus according to the present embodiment. The generating apparatus of FIG. 6 includes an assignment determiner 10. Other configurations are the same as those of the first embodiment and thus a description thereof is omitted.

The assignment determiner 10 determines whether the measured values or the like assigned to the variables of a physical model are appropriate. Specifically, the assignment determiner 10 selects one arbitrary variable from among the variables included in a first residual calculation formula generated by a first residual calculator 3, and generates a third residual calculation formula where a predetermined constant value is substituted for the selected variable. The assignment determiner 10 calculates a third residual e3 by assigning measured values or the like to the variables of the third residual calculation formula, and compares a residual e1 with the residual e3. If the residual e1 is larger than the residual e3, the assignment determiner 10 determines that the assignment of the measured value or the like to the variable for which the constant value is substituted is inappropriate, and thus, removes a term including the variable from the physical model.

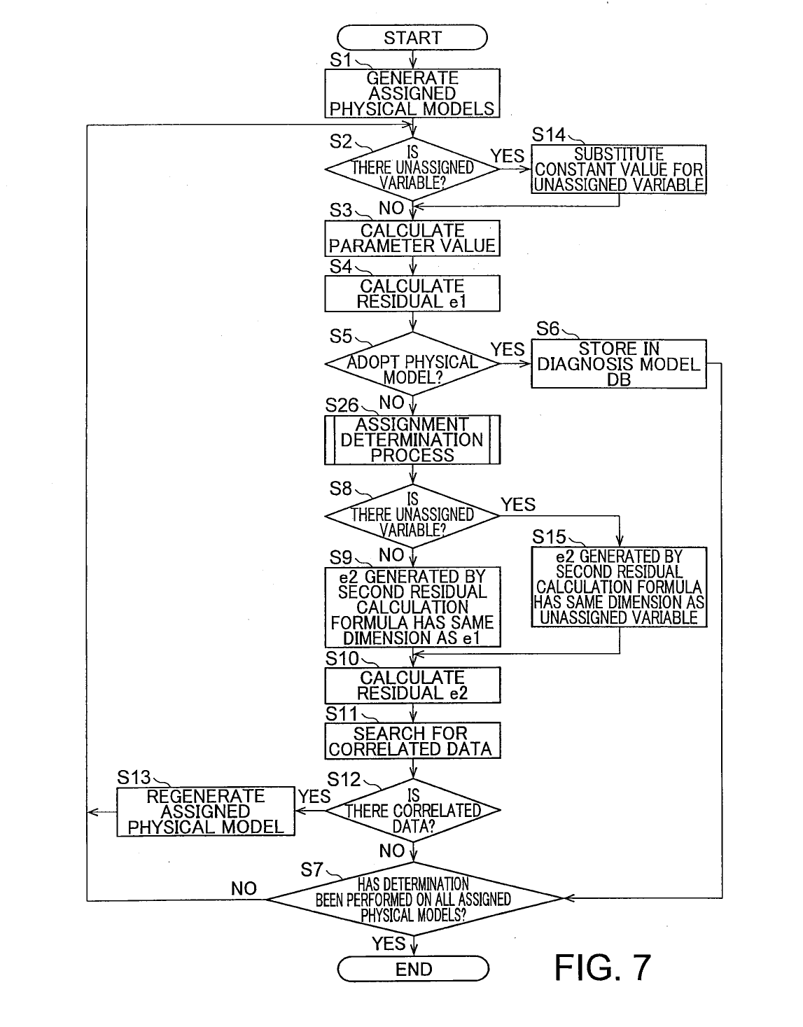

FIG. 7 is a flowchart showing a diagnosis model generation process performed by the generating apparatus according to the present embodiment. As shown in FIG. 7, in the diagnosis model generation process according to the present embodiment, after the physical model is determined not to be adopted at step S5 (NO at step S5), an assignment determination process S26 by the assignment determiner 10 is performed. Then, after the assignment determination process S26 ends, the diagnosis model generation process proceeds to step S8.

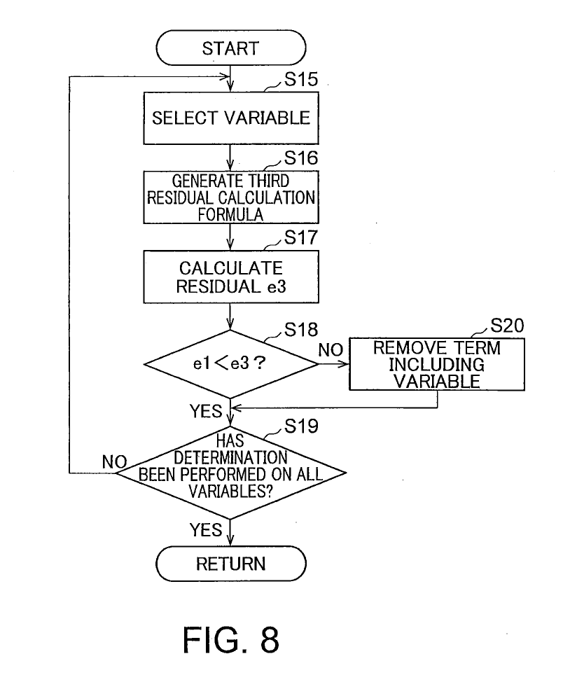

FIG. 8 is a flowchart showing an assignment determination process performed by the assignment determiner 10. When the physical model is determined not to be adopted at step S5 and an assignment determination process starts, the assignment determiner 10 selects one arbitrary variable from among the variables included in a first residual calculation formula (step S15). Here, the first residual calculation formula is the above-described formula (4) and it is assumed that the variable Tao has been selected. Formula (4) is as follows:

e1(t)=(Two(t)−Twi(t))×Fw(t)−[A]×(Tai(t)−Tao(t))×Fa(t) (4)

Then, the assignment determiner 10 generates a third residual calculation formula for calculating a third residual e3 (step S16). The third residual calculation formula is a formula where a predetermined constant value is substituted for the selected variable Tao. As the constant value to be substituted for the selected variable Tao, for example, an average value e1_{AVE} of residuals e1 calculated by the first residual calculator 3 is used. In this case, as the third residual calculation formula, the following equation is generated:

e3(t)=(Two(t)−Twi(t))×Fw(t)−[A]×(Tai(t)−e1_{AvE})×Fa(t) (13)

The assignment determiner 10 calculates a residual e3 by substituting evaluation measured values or the like into the above-described formula (13) (step S17) and compares the residual e1 with the residual e3 (step S18). Specifically, the average value, distribution, maximum value, minimum value, mode, and the like, of residuals e1 are compared with the average value, distribution, maximum value, minimum value, mode, and the like, of residuals e3. If the residual e1 is smaller than the residual e3 (YES at step S18), the assignment determiner 10 determines that a sensor assigned to the variable Tao is appropriate and determines whether an assignment determination process is done for all of the variables included in the first residual calculation formula (4) (step S19). If an assignment determination process is done for all of the variables (YES at step S19), the diagnosis model generation process proceeds to step S8. If there is an unprocessed variable (NO at step S19), the processes after step S15 are repeated for the unprocessed variable.

On the other hand, if the residual e1 is larger than the residual e3 (NO at step S18), the assignment determiner 10 removes a term including the variable Tao from the physical model (step S20). For example, when the physical model is (Two−Twi)×Fw=A×(Tai−Tao)×Fa, a physical model where a term including the variable Tao is removed is as follows:

(Two−Twi)×Fw=A×Fa (14)

The above-described formula (14) generated by the assignment determiner 10 is used as a physical model after step S8.

When, for example, an inappropriate sensor, such as a sensor whose measurement target is different or a sensor for other equipment, is assigned by mistake to a variable of an assigned physical model generated by a physical model generator 1, normally, a physical model determiner 4 determines not to adopt a physical model generated based on the assigned physical model, due to its low diagnostic accuracy. The generating apparatus according to the present embodiment can generate a physical model from such a physical model by removing a variable assigned an inappropriate sensor, and thus, can regenerate a physical model with a high correlation with actual measured values or the like.

### Third Embodiment

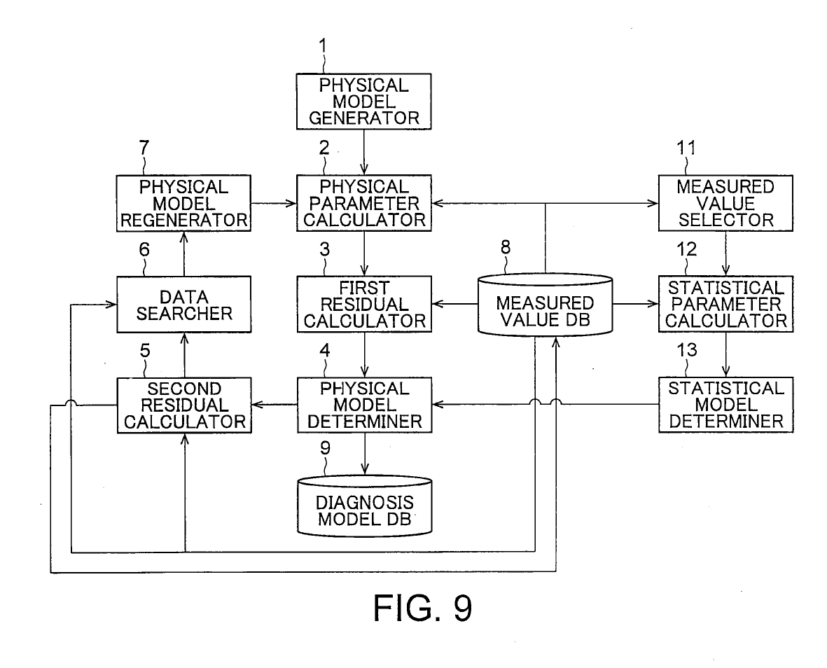

Next, a generating apparatus according to a third embodiment will be described with reference to FIGS. 9 to 11. The generating apparatus according to the present embodiment generates a physical model and a statistical model as diagnosis models. The statistical model is a model for diagnosing abnormalities in equipment from a statistical parameter obtained by performing a statistical process on a plurality of measured values. FIG. 9 is a block diagram showing a functional configuration of a generating apparatus according to the present embodiment. The generating apparatus of FIG. 9 includes a measured value selector 11, a statistical parameter calculator 12, and a statistical model determiner 13. A second residual e2 calculated by a second residual calculator 5 is stored in a measured value DB 8. Other configurations are the same as those of the first embodiment and thus a description thereof is omitted.

The measured value selector 11 stores a statistical model used as a diagnosis model, and selects a measured value group including one or more measured values or the like, which is a target of a statistical process performed using the statistical model, from among a plurality of measured values or the like stored in the measured value DB 8. The measured value selector 11 may select a measured value group which is preset based on expert knowledge or may select, as a measured value group, a plurality of correlated measured values or the like by analyzing the relevance between measured values or the like by graphical modeling or correlation analysis. Alternatively, when the measured value selector 11 selects measured values or the like, the measured value selector 11 may select, as virtual measured values or the like, second residuals e2 which are calculated by the second residual calculator 5 and stored in the measured value DB 8.

The statistical parameter calculator 12 calculates a statistical parameter by performing a statistical process on the measured value group selected by the measured value selector 11. Calculation of a statistical parameter uses evaluation measured values or the like stored in the measured value DB 8. The statistical process performed by the statistical parameter calculator 12 includes, for example, principal component analysis, cluster analysis, discriminant analysis, canonical correlation analysis, SVM, and neural net, but is not limited thereto. A statistical parameter is selected according to the statistical process. For example, when the statistical process is principal component analysis, the statistical parameter calculator 12 calculates a factor loading matrix and a threshold value for abnormality determination, based on the selected measured values or the like.

The statistical model determiner 13 calculates the accuracy of the statistical model based on the statistical parameter calculated by the statistical parameter calculator 12, and compares the calculated accuracy of the statistical model with a predetermined threshold value to determine whether to adopt the statistical model as a diagnosis model. The statistical model adopted by the statistical model determiner 13 is stored in a diagnosis model DB 9.

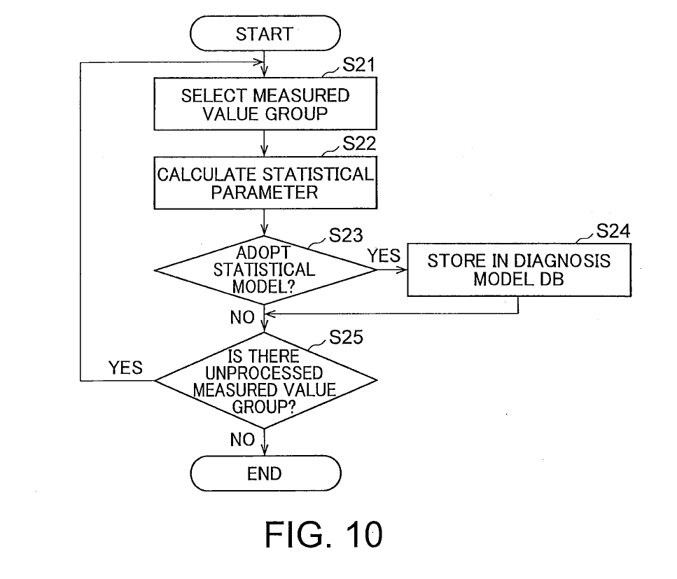

Next, a diagnostic model generation process performed by the generating apparatus according to the present embodiment will be described. In the present embodiment, a residual e2 calculated in the course of a physical model generation process is stored in the measured value DB 8. Other steps of the physical model generation process are the same as those of the above-described embodiments. FIG. 10 is a flowchart showing a statistical model generation process performed by the generating apparatus according to the present embodiment.

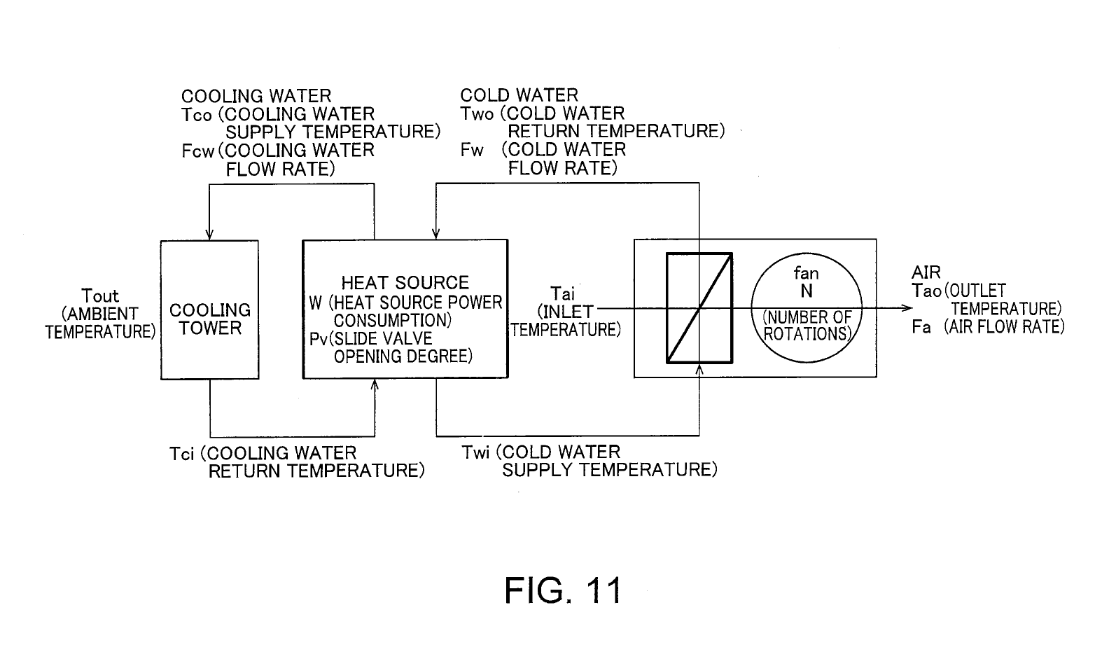

When a statistical model generation process starts, the measured value selector 11 selects a measured value group including at least one measured value or the like (step S21). The measured value selector 11 may select one measured value group or may select a plurality of measured value groups. For example, in the case of air conditioning equipment such as that shown in FIG. 11, as a measured value group, a cooling water supply temperature Tco, a cooling water flow rate Fcw, a cooling water return temperature Tci, a heat source power consumption W, a slide valve opening degree Pv, a cold water supply temperature Twi, a cold water return temperature Two, and a cold water flow rate Fw are selected based on a heat source reference model.

Here, for example, when the cold water flow rate Fw has not been measured, the measured value selector 11 cannot select the above-described measured value group. However, according to the present embodiment, the measured value selector 11 can select, as a measured value group, a residual e2 whose dimension is the same as the measured value or the like, instead of the cold water flow rate Fw.

When the cold water flow rate Fw has not been measured, in a physical model generation process, an assigned physical model where a predetermined constant value [Fw] is substituted for the cold water flow rate Fw, such as that shown below, is generated (step S1).

(Two−Twi)×[Fw]=A×(Tai−Tao)×Fa (15)

If the above-described assigned physical model has not been adopted as a diagnosis model (NO at step S5), a second residual e2 such as that shown below is calculated as follows (step S9) and stored in the measured value DB 8:

e2(t)={[A]×(Tai(t)−Tao(t))−Fa(t)}/(Two(t)−Twi(t))−[Fw] (16)

The above-described residual e2 is an amount obtained by subtracting the predetermined value [Fw] from a cold water flow rate Fw calculated from the physical properties of the air conditioning equipment, and thus, has the same dimension as the cold water flow rate Fw and is correlated with the cold water flow rate Fw. Hence, a statistical model can be generated by selecting the residual e2 as the target of the statistical process, instead of the cold water flow rate Fw.

Hence, in the present embodiment, even when a physical model is adopted as a diagnosis model in the physical model generation process (YES at step S5), it is preferred to calculate a second residual e2. In addition, it is preferred to perform a physical model generation process before a statistical model generation process.

Then, the statistical parameter calculator 12 selects one measured value group from among the measured value groups selected by the measured value selector 11, and calculates a statistical parameter by performing a statistical process on the selected statistical value group (step S22).

Then, the statistical model determiner 13 determines, based on the accuracy of a statistical model whose statistical parameter is calculated by the statistical parameter calculator 12, whether to adopt the statistical model as a diagnosis model (step S23). If the statistical model is adopted by the statistical model determiner 13 (YES at step S23), the statistical model is stored as a diagnosis model in the diagnosis model DB 9 (step S24).

If the statistical model determiner 13 does not adopt the statistical model (NO at step S23) or after the statistical model is stored in the diagnosis model DB 9, the statistical model determiner 13 determines whether there is an unprocessed measured value group (step S25). If processes are done for all of the measured value groups selected by the measured value selector 11 (NO at step S25), the statistical model generation process ends. If there is an unprocessed measured value group (YES at step S25), processing returns to step S21.

As described above, according to the present embodiment, even if a measured value or the like which is a target of a statistical process has not been measured, a statistical model can be generated using a residual e2. Namely, a statistical process can be performed considering a residual e2 calculated in a physical model generation process, as a new measured value or the like.

### Fourth Embodiment

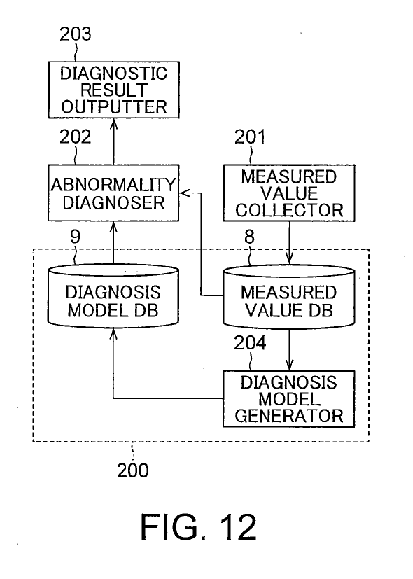

Next, an abnormality diagnostic apparatus will be described as a fourth embodiment. An abnormality diagnostic apparatus according to the present embodiment includes any of the generating apparatuses according to the above-described first to third embodiments. FIG. 12 is a block diagram showing a functional configuration of an abnormality diagnostic apparatus according to the present embodiment. The abnormality diagnostic apparatus of FIG. 12 includes a generating apparatus 200, a measured value collector 201, an abnormality diagnoser 202, and a diagnostic result outputter 203.

In FIG. 12, the generating apparatus 200 includes a diagnosis model generator 204, a measured value DB 8, and a diagnosis model DB 9. The diagnosis model generator 204 is a generic name of all components of the generating apparatus 200 other than the measured value DB 8 and the diagnosis model DB 9.

The measured value collector 201 collects the measured values and control values of sensors provided in equipment which is a diagnostic target. The measured values and control values collected by the measured value collector 201 are stored in the measured value DB 8.

The abnormality diagnoser 202 diagnoses abnormalities in the equipment based on diagnosis models stored in the diagnosis model DB 9 and the measured values or the like stored in the measured value DB 8. The measured values or the like used by the abnormality diagnoser 202 are not evaluation measured values or the like but are measured values or the like for a diagnostic target period.

The diagnostic result outputter 203 is a monitor that outputs a diagnostic result obtained by the abnormality diagnoser 202. A user of the abnormality diagnostic apparatus checks whether there are abnormalities in the equipment, by referring to the diagnostic result outputted from the diagnostic result outputter 203.

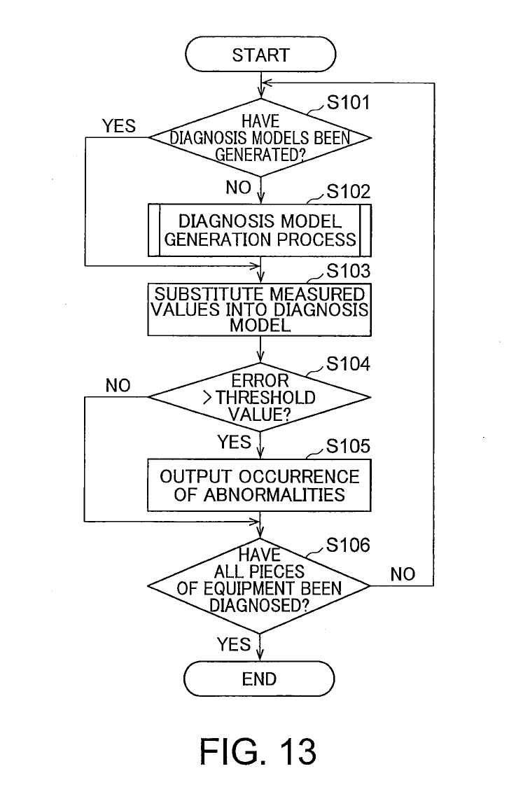

FIG. 13 is a flowchart showing an abnormality diagnostic process performed by the abnormality diagnostic apparatus. When an abnormality diagnostic process starts, the abnormality diagnoser 202 obtains diagnosis models by referring to the diagnosis model DB 9. If diagnosis models have not been generated (NO at step S101), the generating apparatus 200 performs a diagnosis model generation process (step S102). The diagnosis model generation process is as described above.

If diagnosis models such as a physical model and a statistical model have been generated (YES at step S101) or after diagnosis models are generated in the diagnosis model generation process, the abnormality diagnoser 202 obtains measured values or the like for a diagnostic target period from the measured value DB 8, obtains a diagnosis model from the diagnosis model DB 9, and substitutes the measured values or the like into the diagnosis model (step S103).

The abnormality diagnoser 202 compares a value obtained at step S103 with a predetermined threshold value for abnormality diagnosis to determine whether abnormalities are occurring in the equipment (step S104). If the occurrence of abnormalities is diagnosed (YES at step S104), a diagnostic result is outputted from the diagnostic result outputter 203 (step S105).

If the abnormality diagnoser 202 diagnoses that abnormalities are not occurring in the equipment (NO at step S104) or after the diagnostic result is outputted, it is determined whether an abnormality diagnostic process for all equipment is done (step S106). If an abnormality diagnostic process for all equipment is done (YES at step S106), the abnormality diagnostic process ends. If there is equipment that has not been subjected to an abnormality diagnostic process (NO at step S106), processing returns to step S101 and an abnormality diagnostic process is performed on a next piece of equipment.

Note that a diagnosis model generation process at step S102 may be performed not only when performing an abnormality diagnostic process but also when additions or changes have been made to equipment, or may be performed periodically.

As described above, the abnormality diagnostic apparatus according to the present embodiment performs equipment abnormality diagnosis using diagnosis models generated by the generating apparatus. Therefore, even when diagnosis models for equipment abnormality diagnosis have not been generated, diagnosis models can be generated promptly and abnormality diagnosis can be performed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A diagnosis model generating apparatus comprising:
a physical parameter calculator to calculate a parameter value of a parameter having an undetermined value of a first physical model, based on the first physical model and measured values, the first physical model representing a relationship between the variables based on a plurality of variables assigned the measured values and the parameter;
a first residual calculator to calculate a first residual of the first physical model, based on the first physical model, the parameter value, and the measured values;
a physical model determiner to determine whether to adopt the first physical model, based on the first residual;
a second residual calculator to calculate a second residual of the first physical model that has not been adopted by the physical model determiner, based on the first physical model, the measured values, and the parameter value;
a searcher to search for a measured value correlated with the second residual from among measured values not assigned to the variables; and
a generator to generate a second physical model based on a variable assigned the measured value searched for by the searcher, the variables of the first physical model, and a newly set parameter having an undetermined value, the second physical model representing a relationship between the variables.

2. The apparatus according to claim 1, wherein, when the first physical model includes an unassigned variable to which the measured value is not assigned, the physical parameter calculator substitutes a predetermined constant value for the unassigned variable.

3. The apparatus according to claim 1, wherein the first residual calculator generates a first residual calculation formula for determining a difference between a left side and a right side of the first physical model, and calculates the first residual by substituting the measured values into the first residual calculation formula.

4. The apparatus according to claim 2, wherein, when the first physical model includes the unassigned variable, the second residual calculator transforms the first physical model such that a left side or a right side is the unassigned variable, generates a second residual calculation formula for determining a difference between a left side and a right side of the transformed model, and calculates the second residual by substituting the measured values into the second residual calculation formula.

5. The apparatus according to claim 3, further comprising an assignment determiner to generate, when the first physical model has not been adopted by the physical model determiner, a third residual calculation formula by substituting a constant value for any one of variables included in the first residual calculation formula, calculate a third residual based on the third residual calculation formula and the measured values, and remove from the first physical model a term including the variable for which the constant value is substituted, based on a result of a comparison between the first residual and the third residual.

6. The apparatus according to claim 1, further comprising:
a measured value selector to select at least one measured value serving as a target of a statistical process performed using a statistical model;
a statistical parameter calculator to calculate a statistical parameter by performing the statistical process on the measured value selected by the measured value selector; and
a statistical model determiner to determine whether to adopt the statistical model, based on the statistical parameter calculated by the statistical parameter calculator.

7. The apparatus according to claim 6, wherein the measured value selector selects the second residual as the measured value serving as the target of a statistical process performed using the statistical model.

8. An abnormality diagnostic apparatus comprising the apparatus according to claim 1.

9. A diagnosis model generation method comprising:
calculating a parameter value of a parameter having an undetermined value of a first physical model, based on the first physical model and measured values, the first physical model representing a relationship between the variables based on a plurality of variables assigned the measured values and the parameter;
calculating a first residual of the first physical model, based on the first physical model, the parameter value, and the measured values;
determining whether to adopt the first physical model, based on the first residual;
calculating a second residual of the first physical model that has not been adopted, based on the first physical model, the measured values, and the parameter value;
searching for a measured value correlated with the second residual from among measured values not assigned to the variables; and
generating a second physical model based on a variable assigned the measured value searched for, the variables of the first physical model, and a newly set parameter having an undetermined value, the second physical model representing a relationship between the variables.
